(19) United States
(12) Patent Application Publication
(10) Pub. No.: US 2018/0187514 A1
(43) Pub. Date: Jul. 5, 2018

(54) METAL TO METAL SINGLE BALL SEAT SYSTEM

(71) Applicant: Halliburton Energy Services, Inc., Houston, TX (US)

(72) Inventors: Peter Derek Walter Inglis, Dundee (GB); Ralph Harvey Echols, III, Plano, TX (US)

(73) Assignee: Halliburton Energy Services, Inc., Houston, TX (US)

(21) Appl. No.: 15/527,286

(22) PCT Filed: Apr. 20, 2016
(86) PCT No.: PCT/US2016/028353

§ 371 Date: May 16, 2017

(51) Int. Cl. E21B 34/06; F16K 5/06; B23P 15/00

(52) U.S. Cl. CPC E21B 34/06; F16K 5/06; E21B 2034/002; B23P 15/001; F16K 5/0689

(57) ABSTRACT

A ball valve is disclosed that includes a valve housing, a first seat surface having a first inner diameter and a first outer diameter, and a second seat surface having a second inner diameter and a second outer diameter. The second inner diameter is larger than the first outer diameter, and may be separated by a channel. A resilient seat surface may be disposed within the channel. The valve further includes a ball that is rotatably movable within the housing and that contacts at least one of the first seat surface and the second seat surface to form a seal.

### FIELD

The present disclosure relates generally to downhole valves.

### BACKGROUND

Wellbores may be drilled into subterranean formations to allow for the extraction of hydrocarbons and other materials. During drilling of such wellbores and during subsequent production of fluids from the wellbore, a variety of processes may be implemented to temporarily isolate fluid flowing into or out of the formation via a segment of tubing in the wellbore. These processes typically involve opening and closing valves, and include, for example, interventions, completion operations, and flow control operations. Ball valves and other types of valves may be operated during the foregoing processes to restrict the flow of fluid through the tubing segment.

### BRIEF DESCRIPTION OF THE DRAWINGS

Illustrative embodiments of the present disclosure are described in detail below with reference to the attached drawing figures, which are incorporated by reference herein, and wherein:

FIG. 1 is a schematic, side view of a valve deployed within a wellbore of a well;

FIG. 2 is a schematic, side view of a ball valve deployed within a wellbore, analogous to the wellbore of FIG. 1;

FIG. 2A is a detail view of the interface between the ball and valve seats of the ball valve of FIG. 2;

FIG. 3 is a schematic, side view of another embodiment of a ball valve deployed within a wellbore, analogous to the wellbore of FIG. 1; and

FIG. 3A is a detail view of the interface between the ball and valve seats of the ball valve of FIG. 3.

The illustrated figures are only exemplary and are not intended to assert or imply any limitation with regard to the environment, architecture, design, or process in which different embodiments may be implemented.

### DETAILED DESCRIPTION

Generally, ball valves include a ball seat that receives a sealing ball that is operable to seal the valve when actuated. Typically, the valve closes when the ball is seated on the ball seat, forming a seal. The seal may be formed along a single radius of contact where the ball contacts the seat. Under high pressure and associated loads, however, forces on the valve may result in deformation of the ball and/or the ball seat. Such deformation may make it difficult to provide a consistent seal throughout the life of the ball valve.

The present disclosure relates to a ball valve having a resilient seat, or sealing surface. An illustrative valve includes a valve housing and a first seat surface having a first inner diameter and a first outer diameter. The valve also includes a second seat surface having a second inner diameter and a second outer diameter. The second inner diameter is larger than the first outer diameter, and the first seat surface and the second seat surface may be fixed relative to each other. A resilient seat surface is disposed within a channel between the first valve seat surface and the second valve seat surface. The valve also includes a ball rotatably movable within the housing. The valve contacts at least one of the first seat surface, and second seat surface, and resilient seat surface to form a seal within the ball valve when the valve is closed.

The resilient material may be formed in any suitable way. For example, the resilient material may be overmolded within the channel and machined to form a common seat surface with the first seat surface and second seat surface. In another embodiment, the resilient material is overmolded within the channel and machined to a height that is offset from the first seat surface and second seat surface when the resilient material is in an uncompressed state. For example, the resilient material may have a 0.01 inch or similar offset to provide an interference fit with the ball of the valve. In some embodiments, the resilient material comprises polyetheretherketone (PEEK), though other suitable plastics and polymers may also be used. For example, the resilient material may be moly-filled PTFE (polytetrafluoroethylene with five to fifteen percent molybdenum sulfide (MoS₂) fillers).

In some embodiments, the resilient material may also or alternatively be used to form the first seat surface. In addition, the valve may include a first seating member that forms the first seat surface. In such embodiments, the first seating member comprises may be formed from a traditional or a resilient material, and may overlie an intermediate resilient member that compresses the first seating member against the ball of the valve.

In the drawings and description that follow, like parts are typically marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness.

The present description is directed to a ball valve for controlling the flow of a fluid in, for example, a wellbore. The valve may include a ball and a plurality of sealing surfaces that are operable to form a sell when contact pressure between the surface of the ball and the surface of a valve seat surface exceeds the fluid pressure being sealed against. The inclusion of a plurality of seats and seat surfaces may provide for redundancy by providing multiple continuous contact surfaces. In addition, one of the seat surfaces may be formed by a resilient material, such as PEEK or a rubber to ensure a more compliant seal than would be achieved using solely metal to metal contact. The resulting seat surfaces are more likely to form a fluid-tight seal that experiences minimal deformation or yielding. These and other advantages will be further described herein.

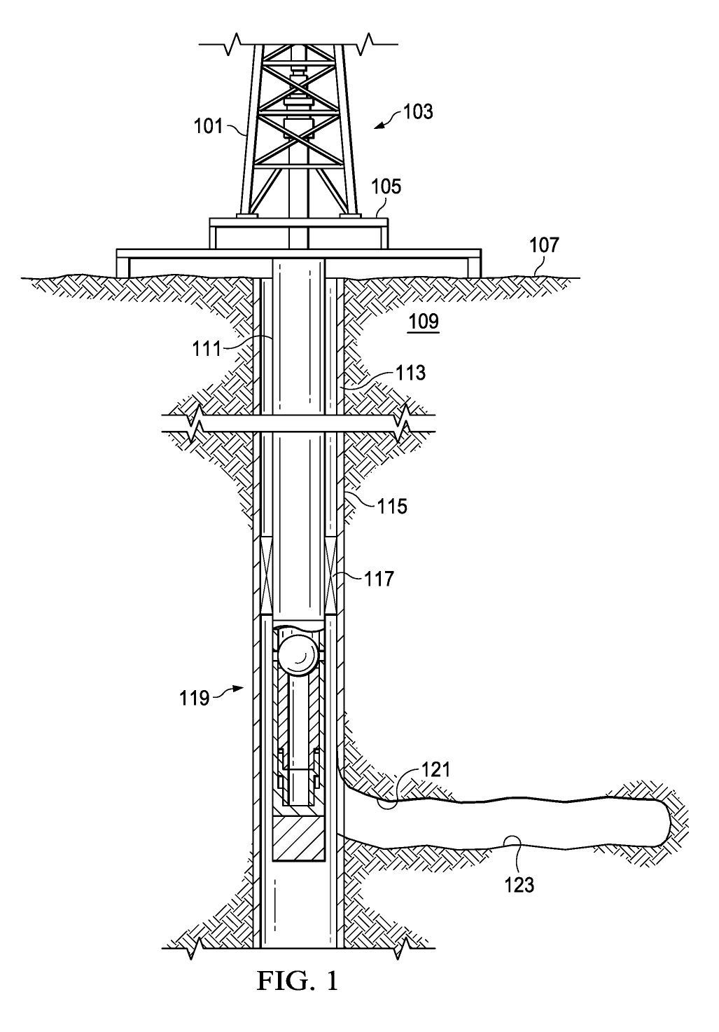

Referring now to the drawings, FIG. 1 shows an example of a wellbore operating environment in which a ball valve 119 may be deployed. In the illustrative embodiment, the operating environment includes a rig 103 positioned on the earth's surface 107 and extending over and around a wellbore 113. The rig 103 may be a workover or drilling rig. The wellbore 113 extends into a subterranean formation 109 that has been formed for the purpose of recovering hydrocarbons. The wellbore 113 extends away from the surface 107 over a vertical portion 115, deviates from a vertical over a deviated portion 121, and transitions to a path that approximately parallels the surface 107 over a horizontal portion 123. In alternative operating environments, all or portions of a wellbore may be vertical, deviated at any suitable angle, horizontal, and/or curved. The wellbore may be a new wellbore, an existing wellbore, a straight wellbore, an extended reach wellbore, a sidetracked wellbore, a multi-lateral wellbore, and other types of wellbores for drilling and completing one or more production zones. Further the wellbore may be used for both producing wells and injection wells.

A wellbore tubing string, shown as tubular 111, includes a ball valve 119 and may be lowered into the subterranean formation 109 for a variety of workover or treatment procedures throughout the life of the well. In the embodiment of FIG. 1, the tubular 111 is illustrated as a production tubing string having a packer 117 and the ball valve 119. The tubular, however, is illustrative and the present disclosure is intended to cover any type of tubing string that may be inserted into a wellbore that includes fluid isolation functionality. For example, the tubing string may include (without limitation) drill pipe, casing, rod strings, and coiled tubing. The packer 117 is shown as an exemplary mechanism for isolating the interior of the tubular 111 from the annular region between the tubular 111 and the wall of the wellbore 113, and may take various forms. Here, the packer 117 is operable to isolate the interior of the tubular 111 from the annular region, thereby allowing the ball valve 119 to control the flow of a fluid through the tubular 111.

As illustrated, the rig 103 includes a derrick 101 with a rig floor 105 through which the tubular 111 extends into the wellbore 113. The rig 103 may comprise a motor driven winch and other associated equipment for extending the tubular 111 into the wellbore 113 to a selected depth. While the operating environment depicted in FIG. 1 refers to a stationary rig 103 for conveying the tubular 111 comprising the ball valve 119 within a land-based wellbore 113, in alternative embodiments, mobile workover rigs, wellbore servicing units (such as coiled tubing units), and the like may be used to lower the tubular 111 comprising the ball valve 119 into the wellbore 113. A wellbore tubular 111 comprising the ball valve 119 may alternatively be used in other operational environments, such as within an offshore wellbore operational environment.

Regardless of the type of operational environment in which the ball valve 119 is used, the ball valve 119 serves to control the flow of fluid through a tubular or conduit, including situations in which the flow of fluid occurs from both sides of the ball valve 119.

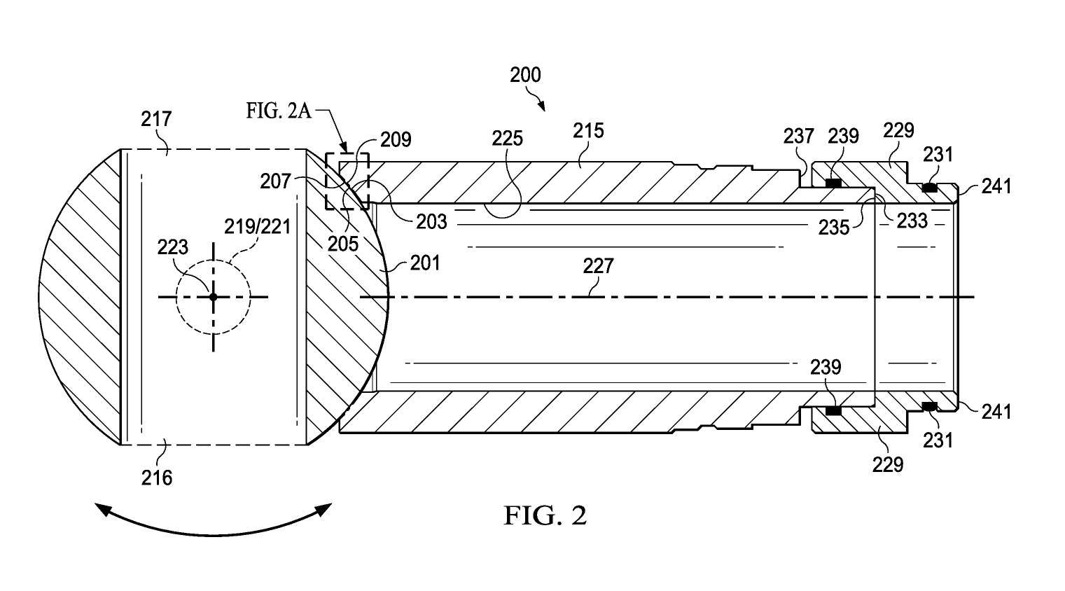

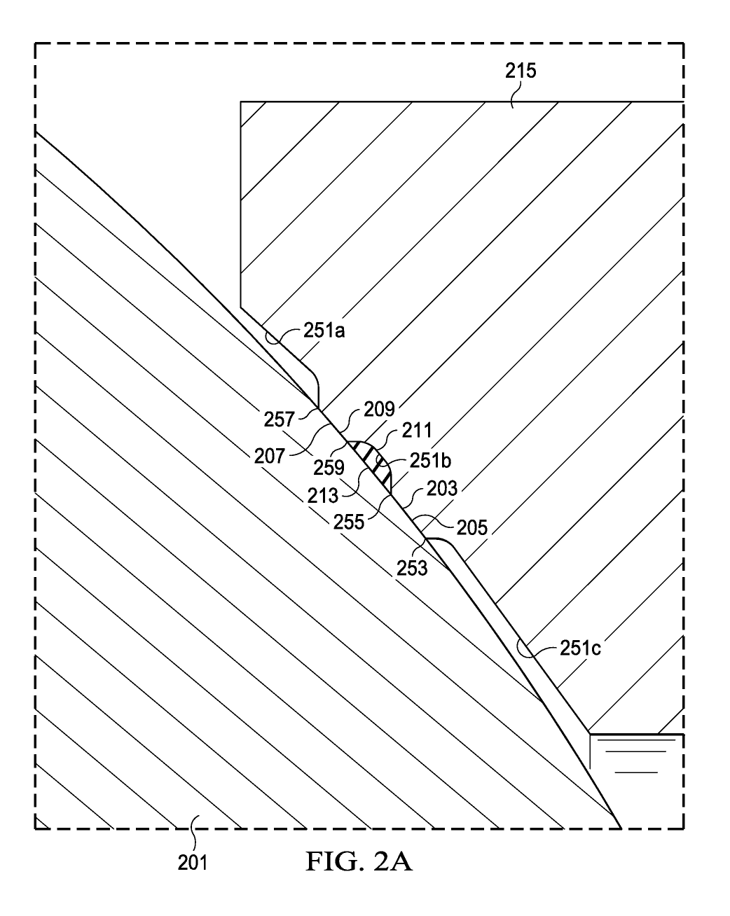

A ball valve 200 that is analogous to the ball valve 119 described with regard to FIG. 1 is described in greater detail with reference to FIG. 2. The ball valve 200 includes a ball 201, which is a sealing ball that may contact a first seat surface 205 on a first seat 203 and a second seat surface 207 on a second seat 209 when oriented in a closed position. The first seat 203 and the second seat 209 may be disposed on a seating member 215. In an embodiment, the first seat 203, second seat 209, and seating member 215 are formed from a rigid material, such as a metal, such that the first seat 203 and second seat 209 may be referred to as rigid seats. As described in more detail below, a resilient seat 211 provides a resilient seat surface 213 and is positioned between the first seat 203 and second seat 209. The resilient seat 211 may be formed by a resilient material placed in a channel between the first seat 203 and second seat 209 on the seating member 215.

An outer housing may be disposed about the ball 201 and the seating member 215. The ball valve 200 may also comprise components (e.g., a threaded connection) located above or below the ball 201 to allow the ball valve 119 to be disposed within and/or coupled to a tubular and/or other wellbore components (e.g., production subs, downhole tools, screens, etc.). While the following discussion describes a ball valve 200 with two rigid seats and one intermediate resilient seat, it should be understood that any plurality of rigid seats and resilient seats may be used to achieve the results and advantages described herein.

As shown in FIG. 2, the ball valve 200 controls the flow of fluid and may be actuated between an open and closed position. The actuation mechanism may comprise two retaining members on opposite sides of the ball 201 that may be disposed within an outer housing and/or form a portion of the outer housing. The ball 201 may be a truncated sphere with planar surfaces 216, 217 on opposite sides and a fluid passage 216 therethrough. Planar surfaces 216, 217 may each have a cylindrical projection 219, 221 (e.g., trunnion supports) extending outwardly therefrom. An actuation member or means may be arranged to rotate the ball 201 about an axis 223 between the two cylindrical projections 219, 221.

In the open position, the ball 201 is rotated to align the fluid passage therethrough with the fluid passage 225 formed within the seating member 215. The ball 201 may be rotated to a closed position in which the fluid passage of the ball is ninety degrees out of alignment with the fluid passage 225 formed within the seating member 215. The actuation member or means may convert a variety of inputs into a rotation of the ball 201 including a pressure input from above or below the ball valve 200, a longitudinal movement of the housing and/or the ball valve 200, a rotational movement of the housing and/or the ball valve 200, or any combination thereof. The ability to convert these inputs into a rotation of the ball 201 may allow the ball valve 200 to be actuated remotely, for example from the surface of a wellbore. As used herein, the longitudinal direction extends along a central longitudinal axis 227 extending through the ball valve 200, which may in some embodiments, align with the central longitudinal axis 227 of a wellbore tubular in which the ball valve 200 is disposed. As used herein, rotational movement of the ball valve 200 may refer to angular motion about the central longitudinal axis 227 of the ball valve 200, which may be distinct from the rotational axis 223 of the ball 201 itself when being rotated between a closed position to an open position, or an open position to a closed position.

As shown in FIG. 2A, the first seat surface 205, second seat surface 207, and resilient seat surface 213 may be in contact with the ball 201 to seal against the flow of fluid through the ball valve 200 when the ball valve 200 is in a closed position. The first seat 203 and the second seat 209 may comprise raised lands or protrusions on the surface of the seating member 215. In an embodiment, the first seat 203 and/or the second seat 209 may have a stepped configuration on the surface of the seating member 215. Correspondingly, the resilient seat 213 may comprise a gasket or similar resilient material disposed between the first seat 203 and second seat 209 that flattens against the surface of the ball 201 as the ball 201 rotates into a closed position.

The first seat surface 205 and second seat surface 207 may be spherically matched to the ball 201 during the manufacturing process by starting with a spherically matched surface on the seating member 215 and removing a portion of the seating member 215 so that the first seat 203 with first seat surface 205 and the second seat 209 with the second seat surface 207 remain. A variety of manufacturing techniques such as etching, abrasion, milling, or any other technique may be used to remove portions 251a, 251b, and 251c of the seating member 215 to form the first seat 203, second seat 209, and corresponding first seat surface 205 and second seat surface 207. To form the resilient seat 211, a resilient material may be placed in the removed portion 251b. Here, it is noted that while the section 251b is shown as having open angles at the edges, it may be alternatively formed to have restraining features such as closed angles at the edges to better retain the resilient material that forms the resilient seat 211. Further, it is noted that the resilient material may be formed or installed in any suitable fashion. For example, the resilient material may be molded and machined in situ installed separately (e.g., similar to a gasket).

In another embodiment, the first seat 203 and the second seat 209 (and removed portions 251a, 251b, 251c) may be formed on the seating member 215 and subsequently machined to have a spherically matched surface with the ball 201. The first seat 203, the second seat 209, and the seating member 215 may be formed of a suitable material such as metal. Suitable metals may be chosen based on several considerations including, but not limited to, the expected operating conditions of the ball valve 200 (e.g., the temperature, the operating pressures), the expected forces on the ball valve 200, and the chemical composition of the fluid in contact with the components of the ball valve 200. The ball 201 may also be formed from a suitable metal so that the seal formed between the ball 201 and the first seat surface 205 and/or the second seat surface 207 comprises a metal to metal contact. Correspondingly, the resilient material forming the resilient seat 211 may be formed from a rubber or polymer, such as polyetheretherketone (PEEK) or any other suitable polymer.

As shown in FIG. 2A, the first seat surface 205 and the second seat surface 207 may be in contact with ball 201. The first seat 203 with first seat surface 205 and the second seat 209 with the second seat surface 207 may be positioned on the seating member 215 so that a pressure boost effect (i.e., a piston effect) acts to aid in forming a seal and balance the load on the ball 201, as described in more detail below. In an embodiment, a first edge 253 of first seat surface 205 may be located at a first diameter as measured across the central longitudinal axis 227 of the ball valve 200, and a second edge 255 of first seat surface 205 may be located at a second diameter that is larger than the first diameter as measured across the central longitudinal axis 227 of the ball valve 200. A first edge 257 of second seat surface 207 may be located at a diameter fourth diameter as measured across the central longitudinal axis 227, and of second seat surface 207 may be located at a third diameter as measured through the central longitudinal axis 227, where the third diameter is larger than the second diameter and the fourth diameter is larger than the third diameter. The various diameters correspond to distances at which the seat surfaces 203, 205 contact the ball 201, and may be referred to as “seat surface diameters.”

Referring again to FIG. 2, the ball valve 200 may also comprise a body member 229. The body member 229 may be slidingly engaged with seating member 215. A first seal 239, for example an O-ring, may be provided between the outer surface of the seating member 215 and the inner surface of the body member 229 to prevent the flow of fluids between the body member 229 and the seating member 215. An upper surface 233 of the body member 229 may engage a lower surface 235 of the seating member 215 to transfer any force from the body member 229 to the seating member 215 when pressure is applied from below the ball valve 200. A second seal 231 may be provided between the outer surface of the body member 229 and the housing of the ball valve 200 to allow for a sliding engagement of the body member 229 within the housing while preventing the flow of fluids between the body member 229 and the housing. The lower surface 237 of the seating member 215 over which pressure from above may act has an outer surface located at the seal 239. The lower surface 241 of the body member 229 over which pressure from below may act has an outer surface located at seal 231.

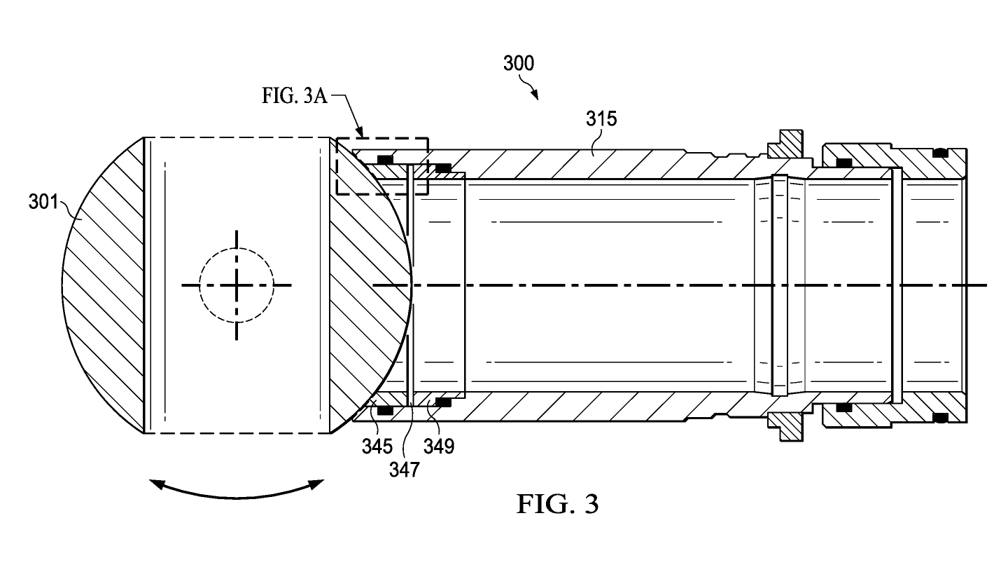

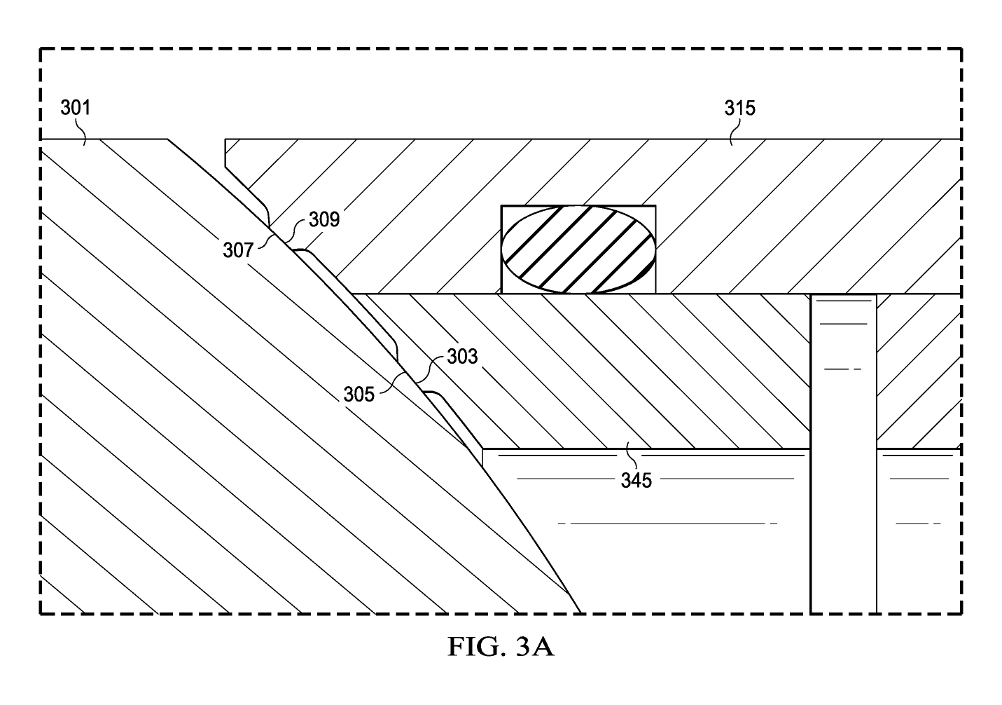

Referring now to FIGS. 3 and 3A, an embodiment of a valve 300 includes a ball 301 and operates in a manner similar to the valve 200 of FIG. 2. The valve 300 of FIG. 3, however, differs from the valve 200 and several respects. The valve 300 includes a valve seat housing 315. The valve seat housing 315 forms at least a portion of the valve seat. An inner seating member 345 is disposed within a cutaway 351 form within the valve seat housing 315.

The inner seating member 345 includes resilient seat 303 having a first seat surface 305, as shown in detail in FIG. 3A. The first seat surface 305 engages the surface of the ball 301 when the valve is it a closed state, and operates analogously to the first seating surface 205 described with regard to FIGS. 2 and 2A. In an embodiment, the inner seating member 345 is made from a resilient material, such as PEEK or another suitable ruling material, and may thereby form a resilient seating member having a resilient seat surface that sealed against the surface of the ball 301 when the valve 300 and the close state and the resilient seat surface is compressed against the surface of the ball 301.

The valve seat housing 315 also includes a second seat 309 having a second seat surface 307 that functions analogously to the second seat surface 207 described above with regard to FIGS. 2 and 2A. In another embodiment, the first seat 303 and second seat 309 may both be formed from a metal. In such an embodiment, however, the inner seating member 345 may be an upper seating member that is positioned above a lower supporting member 349 and an intermediate resilient member 347 that is compressed when the valve ball rotates into a closed position to seal against the first seat 303. In operation, the embodiments of FIGS. 2 and 3 may function analogously with regard to the engagement of the ball with the various seat surfaces.

For example, the seat surfaces may create a redundancy to allow the valve to maintain a seal, and the use of a resilient material may enhance sealing regardless of whether the resilient material is included between the first seat surface and second seat surface, as a seat member that forms the first seat surface, and as a resilient supporting layer than underlies a first seat surface. Referring again to FIGS. 2 and 2A, in operation, when pressure is acting from above, the second edge 259 of the second seat surface 207 may act as a secondary seal with a pressure boost effect being created due to the action of the pressure from above on the differential area between the sealing diameter of the second edge 259 and the sealing diameter of the seating member 215. Somewhat similarly, the second edge 255 of the first seat surface 205 may act as a tertiary seal when pressure acts from above with a pressure boost effect being created due to the action of the pressure from above on the differential area between the sealing diameter of the second edge 255 of the first seat surface 205 and the sealing diameter of the seating member 215. When pressure is acting from below, the second edge 255 of the first seat surface 205 may act as a secondary seal with a pressure boost effect being created due to the action of the pressure from below on the differential area between the diameter of the second edge 255 and the sealing diameter of the body member 229. The second edge 259 of the second seat surface 207 may act as a tertiary seal when pressure acts from below with a pressure boost effect being created due to the action of the pressure from below on the differential area between the diameter of the second edge 259 of the second seat surface 207 and the sealing diameter of the body member 229. In either instance, sealing of the valve 200 may be enhanced, and the leak rate of the valve reduced, by the presence of the resilient material at the resilient seat surface 213. Similar enhancement may be achieved when, as shown in the embodiment of FIGS. 3 and 3A the inner seating member 345 is made from a resilient material or an intermediate resilient member 347 is provided below the inner seating member 345.

Returning to FIG. 1, the ball valve 119 may be used to control the flow of a fluid in a subterranean wellbore 113. In an embodiment, a ball valve 119 as described herein may be provided and disposed within the wellbore 113 in a subterranean formation 109. The ball valve 119 may form a part of a wellbore tubular string 111 and may be conveyed into and/or out of the wellbore 113 as part of the wellbore tubular string 111. Additional wellbore components such as one or more zonal isolation devices 117 may be used in conjunction with the ball valve 119 to control the flow of a fluid within the wellbore 113. In some embodiments, one or more ball valves 119 may be used with a wellbore tubular string 111 to control the flow of fluids within various zones of wellbore 113. The use of the ball valve 119 as disclosed herein may allow for control of the flow of a fluid into or out of the wellbore. In order to control the flow of a fluid in the wellbore 113, the ball valve 119 may be activated from an open position to a closed position or from a closed position to an open position. In an embodiment, the ball valve 119 may be activated to any point in between an open position and a closed position.

While the ball valve 119 is depicted in FIG. 2 with the seats 201, 203 and corresponding seat surfaces 205, 207 located below the ball 201, the seats 201, 203 may instead be located in alternative orientations with respect to the ball 201. For example, the seats 201, 203 and corresponding seat surfaces 205, 207 may be positioned so as to contact the upper side of the ball 201. The plurality of seat surfaces may be located on the same hemisphere of the ball 201. In a further embodiment, a plurality of seat surfaces may be positioned so as to act on different hemispheres of the ball 201, for example on both the upper and lower sides of the ball 201. Such an embodiment may provide a plurality of redundant seat surfaces. While the ball valve 119 is described in the context of a subterranean wellbore, it should be understood that the ball valve 119 of the present disclosure may be used in an industry or use in which it is desirable to control the flow of a fluid that may have a differential pressure from either side of the ball valve 119.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification.

For clarity, as referenced herein, the following terms should be understood as follows unless expressly defined otherwise. “Connect,” “engage,” “couple,” “attach,” and similar terms describing a connection or interaction between features are not meant to include indirect connections or interactions between the relevant features. The terms “including” and “comprising” are open-ended and should be interpreted to mean “including, but not limited to . . . ” “Up,” “upper,” “upward,” “upstream,” and “above” are intended to indicate the direction toward the surface of the wellbore. “Down,” “lower,” “downward,” “downstream,” and “below” are intended to indicate the direction toward the terminal end of the well, regardless of the wellbore orientation. Further, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

The present disclosure may also be understood as including at least the following clauses:

Clause 1: A ball valve comprising: a valve housing; a first seat surface having a first inner diameter and a first outer diameter; a second seat surface having a second inner diameter and a second outer diameter, the second inner diameter being larger than the first outer diameter, wherein the first seat surface and the second seat surface are fixed relative to each other; a resilient seat surface disposed within a channel between the first valve seat surface and the second valve seat surface; and a ball rotatably movable within the housing and contacting and at least one of the first seat surface and the second seat surface to form a seal within the ball valve; wherein pressure acting in a first direction and in a second direction opposite the first direction increases the contact pressure of the first seat surface, resilient seat surface, and the second seat surface with the ball.

Clause 2: The ball valve of clause 1, wherein the resilient material is overmolded within the channel, and machined to form a common seat surface with the first seat surface and second seat surface.

Clause 3: The ball valve of clause 1 or 2, wherein the resilient material is overmolded within the channel, and machined to a height that is offset from the first seat surface and second seat surface when the resilient material is in an uncompressed state.

Clause 4: The ball valve of any of clauses 1-3, wherein the resilient material comprises PEEK.

Clause 5: The ball valve of any of clauses 1-4, wherein the first seat surface comprises a resilient material.

Clause 6: The ball valve of any of clauses 1-5, further comprising a first seating member, wherein the first seating member comprises the first seat surface, and wherein the first seating member overlies an intermediate resilient member.

Clause 7: A method of forming a ball valve, the method comprising: providing a valve housing, the valve housing having a channel between a first valve seat surface and a second valve seat surface, the first valve seat surface having a first inner diameter and a first outer diameter and the second seat surface having a second inner diameter and a second outer diameter, the second inner diameter being larger than the first outer diameter; and providing a ball within the housing and contacting and at least one of the first seat surface and the second seat surface to form a seal within the ball valve.

Clause 8: The method of clause 7, further comprising providing a resilient material within the channel.

Clause 9: The method of clause 8, wherein providing the resilient material comprises overmolding the resilient material within the channel, and machining the resilient material to form a common seat surface with the first seat surface and second seat surface.

Clause 10: The method of clause 8, wherein providing the resilient material comprises overmolding the resilient material within the channel, and machining the resilient material to form a seat surface that is offset from the first seat surface and second seat surface when the resilient material is in an uncompressed state.

Clause 11: The method of any of clauses 8-10, wherein the resilient material comprises PEEK.

Clause 12: The method of clause 7, wherein the first seat surface comprises a resilient material.

Clause 13: The method of clause 12, wherein the resilient material comprises PEEK.

Clause 14: The method of clause 7, wherein providing the first seat surface comprises providing a first seating member, wherein the first seating member comprises the first seat surface, and wherein the first seating member overlies an intermediate resilient member.

Clause 15: A ball valve comprising: a valve housing; a first seat surface having a first inner diameter and a first outer diameter, wherein the first seat surface comprises a resilient material; a second seat surface having a second inner diameter and a second outer diameter, the second inner diameter being larger than the first outer diameter, wherein the first seat surface and the second seat surface are fixed relative to each other; a channel between the first valve seat surface and the second valve seat surface; and a ball rotatably movable within the housing and contacting and at least one of the first seat surface and the second seat surface to form a seal within the ball valve; wherein pressure acting in a first direction and in a second direction opposite the first direction increases the contact pressure of the first seat surface and the second seat surface with the ball.

Clause 16: The ball valve of clause 15, further comprising a second resilient material disposed within the channel, wherein the ball contacts the second resilient material when in a closed position.

Clause 17: The ball valve of clause 15 or 16, wherein the second resilient material is overmolded within the channel, and machined to form a common seat surface with the first seat surface and second seat surface.

Clause 18: The ball valve of clause 15 or 16, wherein the resilient material is overmolded within the channel, and machined to a height that is offset from the first seat surface and second seat surface when the resilient material is in an uncompressed state.

Clause 19: The ball valve of any of clauses 15-18, wherein the resilient material comprises PEEK.

Clause 20: The ball valve of any of clause 15-19, further comprising a first seating member, wherein the first seating member comprises the first seat surface, and wherein the first seating member overlies an intermediate resilient member.

1. A ball valve comprising:
a valve housing;
a first seat surface having a first inner diameter and a first outer diameter;
a second seat surface having a second inner diameter and a second outer diameter, the second inner diameter being larger than the first outer diameter, wherein the first seat surface and the second seat surface are fixed relative to each other;
a resilient seat surface disposed within a channel between the first valve seat surface and the second valve seat surface; and
a ball rotatably movable within the housing and contacting and at least one of the first seat surface and the second seat surface to form a seal within the ball valve;
wherein pressure acting in a first direction and in a second direction opposite the first direction increases the contact pressure of the first seat surface, resilient seat surface, and the second seat surface with the ball.

2. The ball valve of claim 1, wherein the resilient material is overmolded within the channel, and machined to form a common seat surface with the first seat surface and second seat surface.

3. The ball valve of claim 1, wherein the resilient material is overmolded within the channel, and machined to a height that is offset from the first seat surface and second seat surface when the resilient material is in an uncompressed state.

4. The ball valve of claim 1, wherein the resilient material comprises PEEK.

5. The ball valve of claim 1, wherein the first seat surface comprises a resilient material.

6. The ball valve of claim 1, further comprising a first seating member, wherein the first seating member comprises the first seat surface, and wherein the first seating member overlies an intermediate resilient member.

7. A method of forming a ball valve, the method comprising:
providing a valve housing, the valve housing having a channel between a first valve seat surface and a second valve seat surface, the first valve seat surface having a first inner diameter and a first outer diameter and the second seat surface having a second inner diameter and a second outer diameter, the second inner diameter being larger than the first outer diameter; and
providing a ball within the housing and contacting and at least one of the first seat surface and the second seat surface to form a seal within the ball valve.

8. The method of claim 7, further comprising providing a resilient material within the channel.

9. The method of claim 8, wherein providing the resilient material comprises overmolding the resilient material within the channel, and machining the resilient material to form a common seat surface with the first seat surface and second seat surface.

10. The method of claim 8, wherein providing the resilient material comprises overmolding the resilient material within the channel, and machining the resilient material to form a seat surface that is offset from the first seat surface and second seat surface when the resilient material is in an uncompressed state.

11. The method of claim 8, wherein the resilient material comprises PEEK.

12. The method of claim 7, wherein the first seat surface comprises a resilient material.

13. The method of claim 12, wherein the resilient material comprises PEEK.

14. The method of claim 7, wherein providing the first seat surface comprises providing a first seating member, wherein the first seating member comprises the first seat surface, and wherein the first seating member overlies an intermediate resilient member.

15. A ball valve comprising:
a valve housing;
a first seat surface having a first inner diameter and a first outer diameter, wherein the first seat surface comprises a resilient material;
a second seat surface having a second inner diameter and a second outer diameter, the second inner diameter being larger than the first outer diameter, wherein the first seat surface and the second seat surface are fixed relative to each other;
a channel between the first valve seat surface and the second valve seat surface; and
a ball rotatably movable within the housing and contacting and at least one of the first seat surface and the second seat surface to form a seal within the ball valve;
wherein pressure acting in a first direction and in a second direction opposite the first direction increases the contact pressure of the first seat surface and the second seat surface with the ball.

16. The ball valve of claim 15, further comprising a second resilient material disposed within the channel, wherein the ball contacts the second resilient material when in a closed position.

17. The ball valve of claim 16, wherein the second resilient material is overmolded within the channel, and machined to form a common seat surface with the first seat surface and second seat surface.

18. The ball valve of claim 16, wherein the resilient material is overmolded within the channel, and machined to a height that is offset from the first seat surface and second seat surface when the resilient material is in an uncompressed state.

19. The ball valve of claim 15, wherein the resilient material comprises PEEK.

20. The ball valve of claim 15, further comprising a first seating member, wherein the first seating member comprises the first seat surface, and wherein the first seating member overlies an intermediate resilient member.
